(19) United States
(12) Patent Application Publication
(10) Pub. No.: US 2012/0038829 A1
(43) Pub. Date: Feb. 16, 2012

(54) DISPLAY APPARATUS

(76) Inventors: Hiroshi Mitani, Osaka (JP); Yoshihisa Nagasaki, Osaka (JP); Seiji Nakazawa, Osaka (JP)

(21) Appl. No.: 13/281,859

(22) Filed: Oct. 26, 2011

Related U.S. Application Data
(63) Continuation of application No. PCT/JP2011/001789, filed on Mar. 25, 2011.

(30) Foreign Application Priority Data
Mar. 26, 2010 (JP) 2010-073188

(51) Int. Cl. H04N 9/64

(52) U.S. Cl. 348/649; 348/E09.037

(57) ABSTRACT

A display apparatus includes: input port for receiving input of video signal representing display color in red, green, and blue hues; display portion including pixel with red, green, blue and yellow sub-pixels for performing plasma emission in red, green, blue and yellow hues, respectively; and converter for converting video signal and outputting conversion signal for causing sub-pixels to emit light, respectively, such that display color corresponding to display color represented by video signal is displayed on display portion, wherein conversion signal output by converter includes red and green conversion signals for causing red and green sub-pixels to perform plasma emission at lower luminosity value than luminosity value used in the video signal, respectively, and yellow conversion signal for causing yellow sub-pixel to perform plasma emission, and yellow sub-pixel performs plasma emission with shorter afterglow time than red and green sub-pixels.

### TECHNICAL FIELD

The present invention is related to display apparatuses for providing viewers with a video with little afterglow.

### BACKGROUND OF THE INVENTION

Display apparatuses configured to provide viewers with a video, which is stereoscopically perceived (stereoscopic video), has been developed as a result of recent progresses in the video technologies. A display apparatus typically displays a video including a left frame image, which is viewed by the left eye, and a right frame image, which is viewed by the right eye. The display apparatus transmits a synchronization signal in synchronism with display of the video frame images. A user wears a dedicated eyeglass device to view the stereoscopic video. The eyeglass device executes stereoscopic vision assistance to assist in viewing the video, in response to the synchronization signal transmitted from the display apparatus. If the display apparatus displays the left frame image, the eyeglass device reduces a light amount reaching the right eye of the viewer whereas the eyeglass device increases a light amount reaching the left eye of the viewer. If the display apparatus displays the right frame image, the eyeglass device reduces the light amount reaching the left eye of the viewer whereas the eyeglass device increases the light amount reaching the right eye of the viewer. As a result, the viewer stereoscopically perceives the video displayed by the display apparatus.

Like a standard two-dimensional video, the left and right frame images are depicted by means of the three primary colors such as red, green and blue. Patent Documents 1 and 2 disclose a display apparatus configured to display frame images with yellow, which is the opposite color of blue, in addition to the three primary colors that are red, green and blue. The display apparatus described in Patent Documents 1 and 2 achieves improved color reproducibility by means of the four colors that are red, green, blue and yellow.

A plasma display apparatus, which causes plasma emission of pixels to display a frame image, in particular faces problems about afterglow (cross talk). If the plasma display apparatus alternately displays left and right frame images, in particular, the afterglow of the plasma display adversely affects the view of a stereoscopic video. For example, while the plasma display apparatus displays the right frame image, the viewer may perceive afterglow from the left frame image, which is displayed before the right frame image. Likewise, if the plasma display apparatus displays the left frame image, the viewer may perceive afterglow from the right frame image, which is displayed before the left frame image. As a result, it becomes less likely that the viewer comfortably views the stereoscopic video.

Technologies disclosed in Patent Documents 1 and 2 do not address the problem of the afterglow of a display apparatus employing self-emitting element such as the aforementioned plasma display apparatus. Therefore, there have not been technologies for solving the problem of the aforementioned afterglow.

Patent Document 1: JP 2001-209047 A

Patent Document 2: WO2007/148519

### DISCLOSURE OF THE INVENTION

An object of the present invention is to provide a display apparatus which may provide a video with little afterglow.

A display apparatus according to one aspect of the present invention includes: an input port to which a video signal is input, the video signal representing a display color with a first luminosity value corresponding to a red hue, a second luminosity value corresponding to a green hue, and a third luminosity value corresponding to a blue hue; a display portion including a pixel having a red sub-pixel which causes plasma emission in the red hue, a green sub-pixel which causes plasma emission in the green hue, a blue sub-pixel which causes plasma emission in the blue hue, and a yellow sub-pixel which causes plasma emission in a yellow hue; and a converter configured to convert the video signal into a conversion signal so that the red, green, blue and yellow sub-pixels emit light on the display portion to display a display color which corresponds to the represented display color by the video signal, wherein the conversion signal output by the converter includes at least one of a red conversion signal to cause the plasma emission of the red sub-pixel at a first converted luminosity value that is lower than the first luminosity value and a green conversion signal to cause the plasma emission of the green sub-pixel at a second converted luminosity value that is lower than the second luminosity value, and a yellow conversion signal to cause the plasma emission of the yellow sub-pixel, the plasma emission by the yellow sub-pixel results in a shorter afterglow time than resultant afterglow times from the plasma emissions by the red and green sub-pixels, the red sub-pixel causes the plasma emission at the first converted luminosity value, and the green sub-pixel causes the plasma emission at the second converted luminosity value.

### BRIEF DESCRIPTION OF THE DRAWINGS

FIG. 1A is a schematic block diagram showing a hardware configuration of a display apparatus according to one embodiment.

FIG. 1B is a schematic block diagram showing a functional configuration of a display apparatus according to one embodiment.

FIG. 2 is a schematic view showing a configuration of a video system which includes the display apparatus shown in FIGS. 1A and 1B.

FIG. 3 is a schematic view showing a pixel configuration of a display portion of the display apparatus shown in FIGS. 1A and 1B.

FIG. 4 is a schematic cross-sectional view showing the display portion of the display apparatus shown in FIGS. 1A and 1B.

FIG. 5 is a schematic graph showing afterglow characteristics of fluorescent materials of the display portion shown in FIG. 4.

FIG. 6 is a schematic view showing effects of the afterglow of the fluorescent material on video view.

FIG. 7 is a schematic view showing generation of a conversion signal by a converter of the display apparatus shown in FIGS. 1A and 1B.

FIG. 8 is a table showing results obtained according to the conversion method shown in FIG. 7.

FIG. 9 is a schematic chromaticity diagram showing results obtained according to the conversion method shown in FIG. 7.

FIG. 10 is a schematic view showing another method about the generation of the conversion signal by the converter of the display apparatus shown in FIGS. 1A and 1B.

FIG. 11 is a schematic view showing yet another method about the generation of the conversion signal by the converter of the display apparatus shown in FIGS. 1A and 1B.

FIG. 12 is a schematic view showing a method for determining luminosity value by means of the lookup tables shown in FIG. 11.

### DETAILED DESCRIPTION OF THE INVENTION

A display apparatus according to one embodiment is described hereinafter with reference to the accompanying drawings. It should be noted that configurations, arrangements, shapes and so on depicted in the drawings as well as descriptions relating to the drawings are provided merely for facilitating to understand principles of the display apparatus. Therefore the principles of the display apparatus are in no way limited to these.

### (Configuration of Display Apparatus)

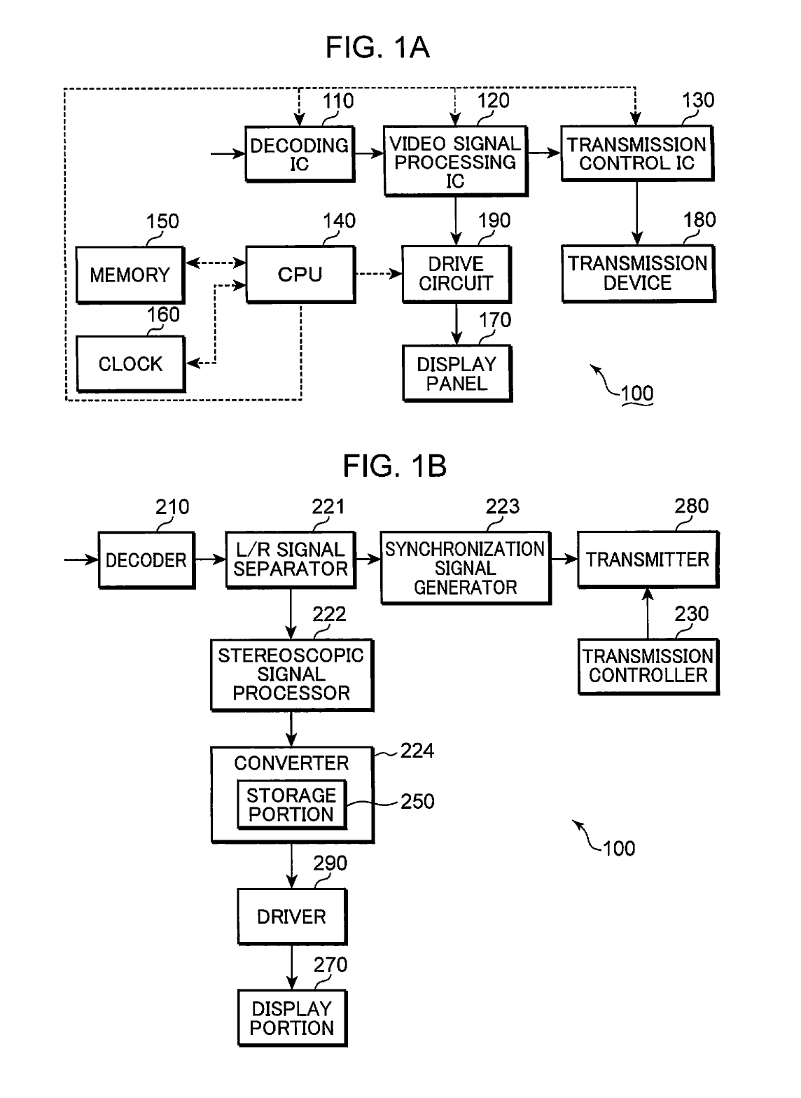

FIGS. 1A and 1B are schematic block diagrams showing a configuration of the display apparatus. FIG. 1A is a schematic block diagram showing a hardware configuration of the display apparatus. FIG. 1B is a schematic block diagram showing a functional configuration of the display apparatus. The display apparatus is described with reference to FIGS. 1A and 1B.

As shown in FIG. 1A, the display apparatus 100 includes a decoding IC 110, a video signal processing IC 120, a transmission control IC 130, a CPU 140, a memory 150, a clock 160, a drive circuit 190, a display panel 170 and a transmission device 180.

An encoded video signal is input to the decoding IC 110 of the display apparatus 100. The decoding IC 110 decodes the video signal to output video data in a predetermined format. Various methods such as MPEG (Motion Picture Experts Group)-2, MPEG-4 and H264 may be used to decode the video.

The decoded video data is used as a video signal which represents display colors of pixels of the display panel 170 by means of a first luminosity value corresponding to a red hue, a second luminosity value corresponding to a green hue and a third luminosity value corresponding to a blue hue.

The video signal processing IC 120 performs signal processes in relation to stereoscopic video display. The video signal processing IC 120 processes the video signal to display the video data from the decoding IC 110 as a stereoscopic video. The video signal processing IC 120 detects a left frame image viewed by the left eye and a right frame image viewed by the right eye from the video data decoded by the decoding IC 110. The detected left and right frame images are alternately displayed on the display panel 170, which is driven by the drive circuit 190. Alternatively, the left and right frame images may be automatically generated from the video data output by the decoding IC 110. The video signal processing IC 120 alternately outputs the generated left and right frame images to the display panel 170 via the drive circuit 190. After the signal processes relating to the stereoscopic video display, the video signal processing IC 120 generates an output signal, which conforms to a signal input method of the display panel 170.

The video signal processing IC 120 converts the decoded video signal into a conversion signal. The conversion signal is generated to display a display color, which the decoded video data defines for each pixel, by means of a red hue, a green hue, a blue hue and a yellow hue. The conversion signal is output to the drive circuit 190.

It should be noted that the video signal processing IC 120 may execute other processes than the aforementioned processes. For example, the video signal processing IC 120 may interpolate images between video frames of the video data generated by the decoding IC 110 in accordance with characteristics of the display panel 170 to increase a frame rate of the video.

The transmission control IC 130 generates a synchronization signal in synchronous with the left and right frame images generated by the video signal processing IC 120. The transmission control IC 130 then outputs the generated synchronization signal to the transmission device 180.

The CPU 140 controls constitutional units such as the decoding IC 110 and the video signal processing IC 120, which constitute the display apparatus 100, for example, in accordance with programs recorded in the memory 150 and an external input (not shown). Thus, the CPU 140 may entirely control the display apparatus 100.

The memory 150 is used as a region for recording the programs executed by the CPU 140 and temporary data generated during execution of the programs. A volatile RAM (Random Access Memory) or a non-volatile ROM (Read Only Memory) may be used as the memory 150.

The clock 160 supplies a clock signal to the CPU 140 and other constitutional components. The clock signal serves as an operational reference of each IC.

The video signal processed by the video signal processing IC 120 is input to the drive circuit 190. The drive circuit 190 drives the display panel 170 in response to the input video signal. In this embodiment, the aforementioned conversion signal is input as the video signal. As described hereinafter, each pixel of the display panel 170 includes sub-pixels, which cause plasma emissions in a red hue, a green hue, a blue hue and a yellow hue, respectively. Therefore, the drive circuit 190 drives the display panel 170 in response to the conversion signal to emit light from the sub-pixel of the red hue (to be referred hereinafter to as the red sub-pixel), the sub-pixel of the green hue (to be referred hereinafter to as the green sub-pixel), the sub-pixel of the blue hue (to be referred hereinafter to as the blue sub-pixel), and the sub-pixel of the yellow hue (to be referred hereinafter to as the yellow sub-pixel), respectively.

The video signal (the left and right frame images) output from the video signal processing IC 120 is displayed on the display panel 170 driven by the drive circuit 190. As described hereinafter, a viewer wearing an eyeglass device stereoscopically perceives the frame images displayed on the display panel 170 by means of stereoscopic vision assistance performed by the eyeglass device. In this embodiment, a PDP (Plasma Display Panel) may be preferably used as the display panel 170.

The transmission device 180 outputs the synchronization signal to the eyeglass device under control of the transmission control IC 130. As described hereinafter, the eyeglass device worn by the viewer executes the stereoscopic vision assistance in response to the synchronization signal so that the video displayed on the display panel 170 is stereoscopically perceived. For example, an infrared light emitter, an RF transmitter or another device configured to transmit the synchronization signal may be preferably used as the transmission device 180.

As shown in FIG. 1B, the display apparatus 100 includes a decoder 210, an L/R signal separator 221, a stereoscopic signal processor 222, a converter 224, a driver 290, a display portion 270, a synchronization signal generator 223, a transmission controller 230 and a transmitter 280.

The decoder 210 corresponds to the decoding IC 110 described with reference to FIG. 1A. The encoded video signal is input to the decoder 210.

The L/R signal separator 221 generates or separates a left video signal and a right video signal (the left and right frame images) from the video signal decoded by the decoder 210.

The stereoscopic signal processor 222 adjusts the left and right video signals separated by the L/R signal separator 221 in accordance with characteristics of the display portion 270 to display a video, which is viewed through the eyeglass device. For example, the stereoscopic signal processor 222 executes processes to adjust parallax between the left and right frame images in accordance with a size of a display surface of the display portion 270. It should be noted that the display portion 270 corresponds to the display panel 170 depicted in FIG. 1A. In this embodiment, the stereoscopic signal processor 222, the L/R signal separator 221 and/or the decoder 210 are used as an input port to which the video signal is input. The input video signal represents the display color of each pixel of the display panel 170 by means of the first to third luminosity values, which correspond to the red, green and blue hues, respectively.

The synchronization signal generator 223 generates synchronization signals in synchronism or correspondence with the left and right frame images, which are generated by the L/R signal separator 221. Meanwhile, types (for example, waveforms) and generation timings of the synchronization signals are adjusted in accordance with characteristics of the display portion 270.

The converter 224 converts the video signal processed by the stereoscopic signal processor 222 into a conversion signal. As described above, the conversion signal is generated to display a display color, which corresponds to the display color that the decoded video data defines for each pixel, by means of the red, green, blue and yellow hues. The conversion signal is output to the driver 290. The converter 224 may include a storage portion 250. The converter 224 may generate the conversion signal by means of a lookup table (LUT) stored in the storage portion 250.

The L/R signal separator 221, stereoscopic signal processor 222, synchronization signal generator 223 and converter 224 correspond to the video signal processing IC 120 of the hardware configuration described with reference to FIG. 1A. The storage portion 250 corresponds to the memory 150 of FIG. 1A.

The video signal, which is processed by the stereoscopic signal processor 222 and the converter 224, is input to the driver 290. The driver 290 drives the display portion 270 in response to the input video signal. As described above, the display portion 270 corresponds to the display panel 170 shown in FIG. 1A. Each pixel of the display portion 270 includes the red, green, blue and yellow sub-pixels. The driver 290 drives the display portion 270 in response to the conversion signal converted by the converter 224 to emit light from the red, green, blue and yellow sub-pixels, respectively. Thus, each pixel emits light in the display color, which is defined by the video signal output from the stereoscopic signal processor 222. The driver 290 corresponds to the drive circuit 190 shown in FIG. 1A.

The transmitter 280 transmits the synchronization signal generated by the synchronization signal generator 223 to the eyeglass device under control of the transmission controller 230. The transmitter 280 corresponds to the transmission device 180 shown in FIG. 1A.

The transmission controller 230 controls a data volume and a transmission interval of the synchronization signal in transmission. The transmission controller 230 corresponds to the transmission control IC 130 shown in FIG. 1A.

(Video System with Display Apparatus)

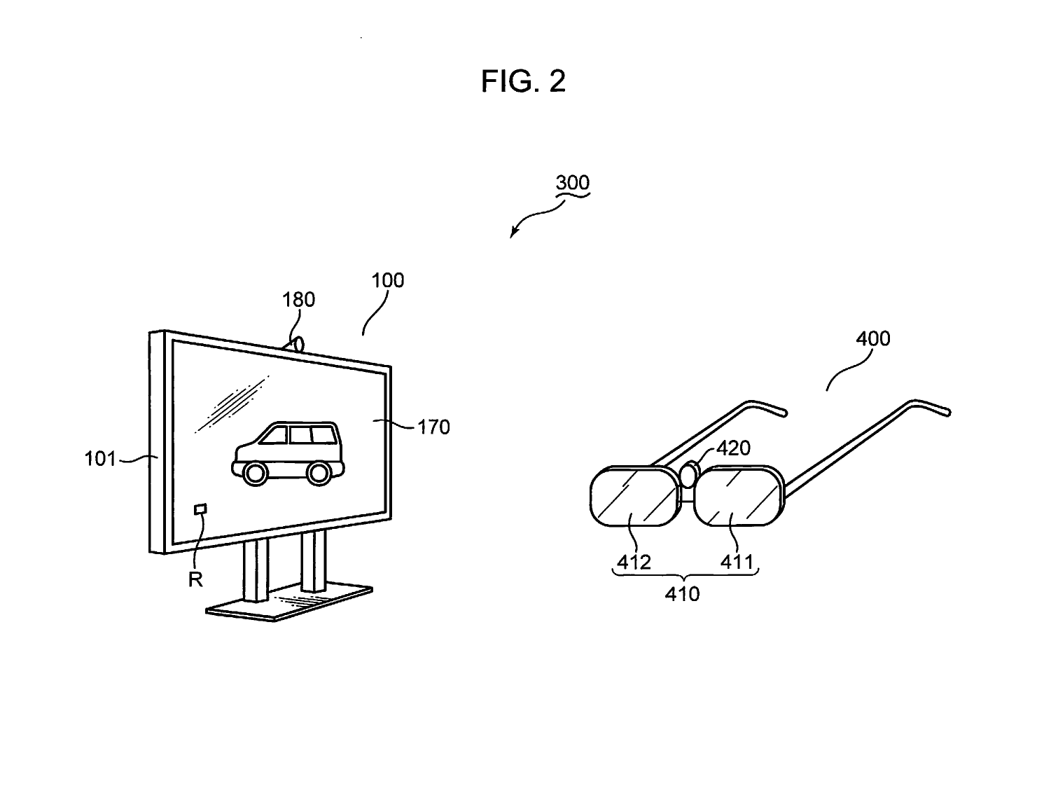

FIG. 2 schematically shows a video system into which the display apparatus 100 is incorporated. The video system with the display apparatus 100 is described with reference to FIGS. 1A to 2.

The video system 300 includes the display apparatus 100, which displays a video, and the eyeglass device 400, which performs the stereoscopic vision assistance that allows a viewer to stereoscopically perceive the video. As described above, the left and right frame images viewed by the left and right eyes are displayed on the display panel 170. In this embodiment, the left and right frame images are alternately displayed on the display panel 170.

The eyeglass device 400 executes the stereoscopic vision assistance so that the viewer views the left and right frame images with the left and right eyes, respectively. As a result, the viewer three-dimensionally (stereoscopically) perceives the video displayed on the display panel 170. If the video is stereoscopically perceived, objects in the left and right frame images (images of objects depicted in the left and right frame images) are perceived so that the objects come out of or into the flat surface of the display panel 170.

The transmission device 180 is situated on an upper edge of a housing 101, which surrounds the periphery of the display panel 170. As described above, the transmission device 180 transmits the synchronization signal in synchronism with the display of the left and right frame images on the display panel 170.

The synchronization signal from the transmission device 180 is received by the eyeglass device 400. The eyeglass device 400 executes the aforementioned stereoscopic vision assistance in response to the received synchronization signal. As a result, the viewer may view the left and right frame images displayed by the display panel 170 with the left and right eyes, respectively.

The eyeglass device 400 in general looks like vision correction eyeglasses. The eyeglass device 400 comprises an optical filter portion 410, which includes a left filter 411 situated in front of the left eye of the viewer wearing the eyeglass device 400 and a right filter 412 situated in front of the right eye. The left and right filters 411, 412 are optical elements configured to adjust transmitted light amounts to the left and right eyes of the viewer, respectively. Accordingly, shutter elements (for example, liquid crystal shutters), which open and close light paths to the left and right eyes of the viewer, respectively, deflection elements (for example, liquid crystal filters), which deflect the transmitted light to the left and right eyes of the viewer, or other optical elements configured to adjust the light amounts may be suitably used as the left and right filters 411, 412.

While the display panel 170 displays the left frame image, the left filter 411 permits light transmission to the left eye of the viewer whereas the right filter 412 suppresses light transmission to the right eye of the viewer. As a result, the viewer may view the left frame image with the left eye. While the display panel 170 displays the right frame image, the right filter 412 allows the light transmission to the right eye of the viewer whereas the left filter 411 suppresses the light transmission to the left eye of the viewer. As a result, the viewer may view the right frame image with the right eye. Under the stereoscopic vision assistance, the viewer may stereoscopically perceive the video displayed by the display panel 170.

The eyeglass device 400 includes a reception device 420 situated between the left and right filters 411, 412. The reception device 420 is used as a receiver configured to receive the synchronization signal, which is transmitted in synchronism with the display of the frame images of the video. The synchronization between the display of the frame images of the video and the stereoscopic vision assistance of the optical filter portion 410 is achieved if the reception device 420 receives the synchronization signal from the transmission device 180. If an infrared light emitter is used as the transmission device 180, an infrared light receiver is suitably used as the reception device 420. If an RF transmitter is used as the transmission device 180, an RF receiver is suitably used as the reception device 420. Alternatively, another element configured to receive the synchronization signal transmitted by the transmission device 180 may be used as the reception device 420.

### (Configuration of Display Panel)

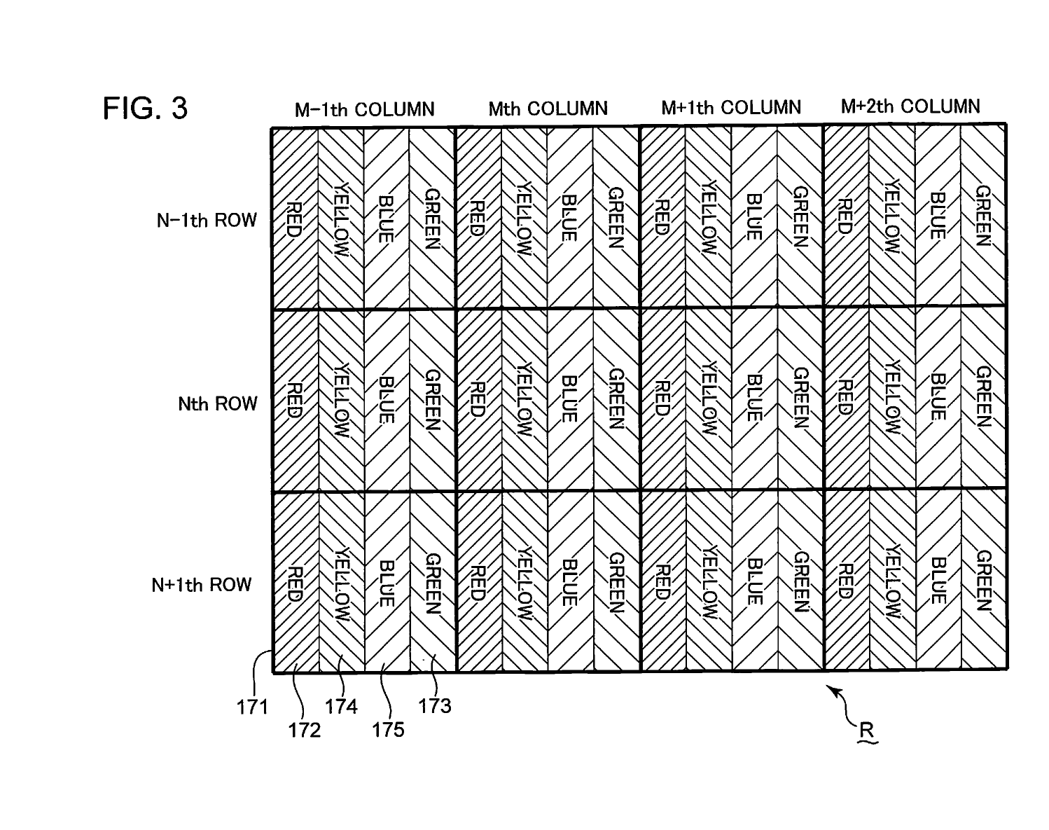

FIG. 3 schematically shows a pixel array in a region R shown in FIG. 2. It should be note that the region R is a given region in the display panel 170. The pixel array in the region R is described with reference to FIGS. 2 and 3.

Pixels 171 are arranged in matrix form on the display panel 170. FIG. 3 shows twelve pixels 171 arranged from the (M−1) to (M+2) columns and from the (N−1) to (N+1) rows. Each pixel 171 includes a red sub-pixel 172, a green sub-pixel 173, a yellow sub-pixel 174 and a blue sub-pixel 175. In this embodiment, the red, yellow, blue and green sub-pixels 172, 174, 175 and 173, which are aligned in the row direction, are vertically elongated rectangular shape, respectively, of which surface areas are substantially equivalent to each other. The yellow sub-pixel 174 is situated between the red sub-pixel 172 at one end of the pixel 171 and the blue sub-pixel 175. The blue sub-pixel 175 is situated between the yellow sub-pixel 174 and the green sub-pixel 173 at the other end of the pixel 171. If the red or blue sub-pixel 172, 175, which has a low spectral luminous efficiency, is situated between the yellow and green sub-pixels 174, 173, which have a higher spectral luminous efficiency, the pixel 171 may preferably emit light.

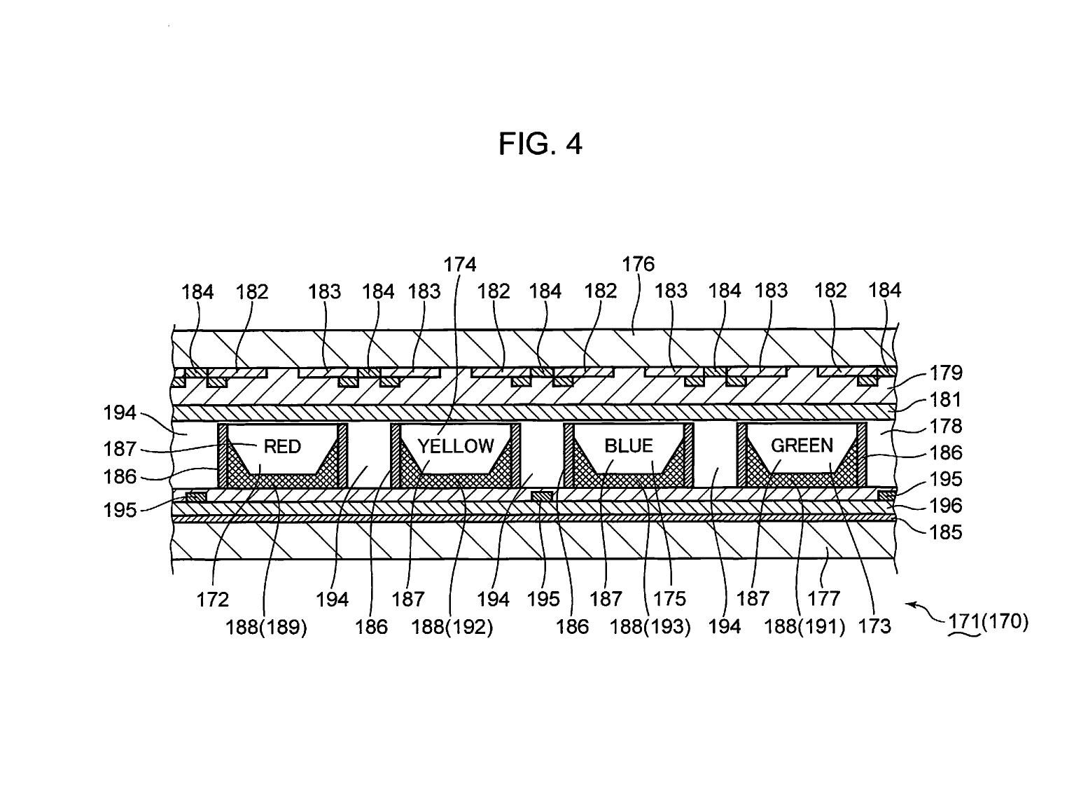

FIG. 4 is a schematic sectional view of the pixel 171. The pixel 171 of the display panel 171 is described with reference to FIGS. 1A, 1B, 3 and 4.

The display panel 170 includes a front substrate 176 made of glass, and a back substrate 177, which is made of glass and opposite to the front substrate 176. A discharge space 178 is defined between the front and back substrates 176, 177. The discharge space 178 is filled with gas such as neon or xenon. With discharge in the discharge space 178, the gas emits ultraviolet rays.

A dielectric layer 179 and a protective layer 181 are formed on a surface of the front substrate 176, which faces the back substrate 177. Scanning electrodes 182 and sustain electrodes 183 are situated between the dielectric layer 179 and the front substrate 176. A pair of the scanning electrodes 182 and a pair of the sustain electrodes 183 are alternately arranged. A light absorption layer 184 formed from a black material is situated between the pairs of scanning electrodes 182 and between the pairs of sustain electrodes 183, respectively.

A data electrode 185 is situated on the back substrate 177 facing the front substrate 176. The data electrode 185 extends in a substantially orthogonal direction to the extension direction of the scanning electrodes 182 and the sustain electrodes 183. A dielectric layer 196 is formed on the data electrode 185.

Partition walls 186 defining the red, yellow, blue and green sub-pixels 172, 174, 175 and 173, respectively, shown in FIG. 3 are situated on the back substrate 177. A fluorescent material layer 188 is formed in a space 187 defined by the partition walls 186. The fluorescent material layer 188 in the space 187 corresponding to the red sub-pixel 172, which is described with reference to FIG. 3, is formed of a red fluorescent material 189. The fluorescent material layer 188 in the space 187 corresponding to the green sub-pixel 173 is formed of a green fluorescent material 191. The fluorescent material layer 188 in the space 187 corresponding to the yellow sub-pixel 174 is formed of a yellow fluorescent material 192. The fluorescent material layer 188 in the space 187 corresponding to the blue sub-pixel 175 is formed of a blue fluorescent material 193. A YVP fluorescent material ((Y, Eu) (PVO₄)) may be exemplified as the red fluorescent material 189. A ZSM fluorescent material ((Zn, Mn)₂ MgSiO₄) may be exemplified as the green fluorescent material 191. A YAG fluorescent material ((Y₃Al₅O₁₂: Ce3+) may be exemplified as the yellow fluorescent material 192. A BAM fluorescent material ((Ba, Eu) MgAl₁₀O₁₇) may be exemplified as the blue fluorescent material 193.

A gap 194 is defined between the spaces 187. A priming electrode 195 is situated on the dielectric layer 196, which faces the scanning electrodes 182. The priming electrode 195 extends in a substantially orthogonal direction to the data electrode 185. The priming electrode 195 performs priming discharge in the gap 194 defined between the priming electrode 195 and the scanning electrodes 182.

As described with reference to FIGS. 1A and 1B, the drive circuit 190 drives the display panel 170 to cause the discharge in the space 187 in response to the conversion signal. As a result, the gas in the space 187 is excited to emit excited ultraviolet rays. The red, green, yellow and blue fluorescent materials 189, 191, 192 and 193 are subjected to plasma emission by the excited ultraviolet rays.

### (Afterglow Characteristics)

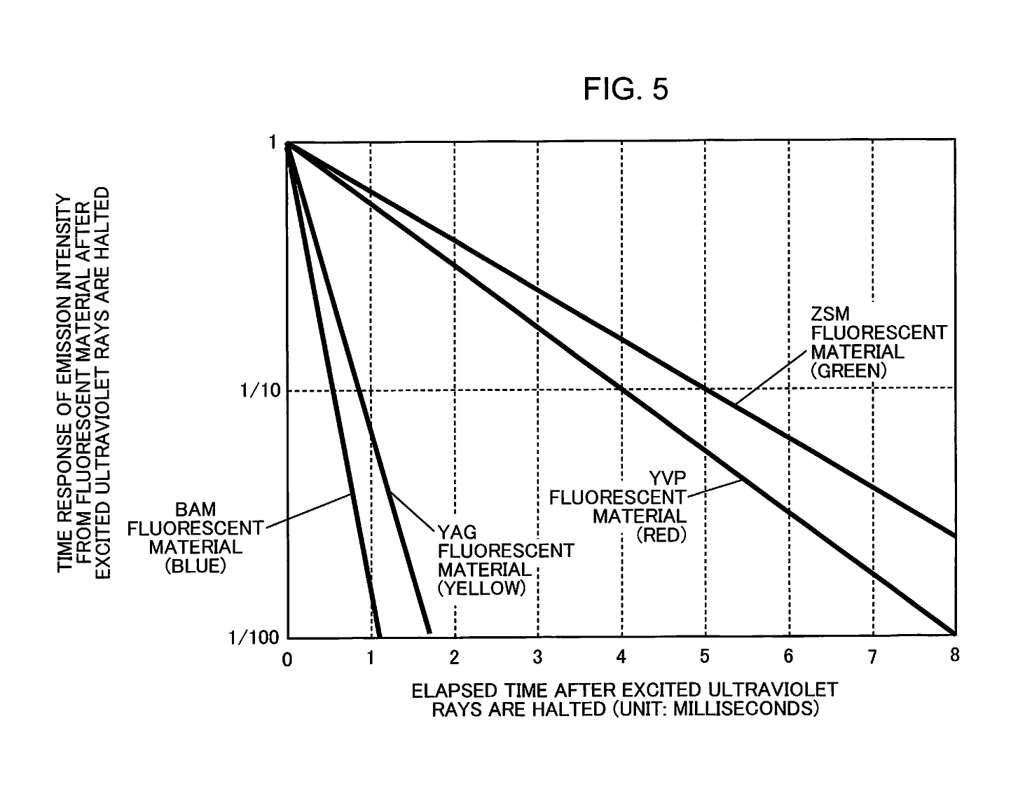

FIG. 5 is a graph showing afterglow characteristics of the red, green, yellow and blue fluorescent materials 189, 191, 192 and 193. The abscissa of the graph shows an elapsed time after halt of the excited ultraviolet rays. The ordinate of the graph shows a time response of emission intensity from the fluorescent material after the halt of the excited ultraviolet rays. The afterglow characteristics of the red, green, yellow and blue fluorescent materials 189, 191, 192 and 193 are described with reference to FIGS. 3 and 5.

As shown in FIG. 5, the emission intensities of the blue fluorescent material (BAM fluorescent material) 193 and the yellow fluorescent material (YAG fluorescent material) 192 fall to or below 1/10 within one millisecond after the halt of the excited ultraviolet rays. On the other hand, it takes substantially four milliseconds for the emission intensity of the red fluorescent material (YVP fluorescent material) 189 to fall to or below 1/10 after the halt of the excited ultraviolet rays. It takes substantially five seconds for the emission intensity of the green fluorescent material (ZSM fluorescent material) 191 to fall to or below 1/10 after the halt of the excited ultraviolet rays.

In this embodiment, the term “a long afterglow time” or similar terms means that a long time is required for the emission intensity to fall to a predetermined value after the halt of the excited ultraviolet rays. The term “a short afterglow time” or similar terms means that a short time is required for the emission intensity to fall to the predetermined value after the halt of the excited ultraviolet rays. It is figured out from FIG. 5 that the blue and yellow fluorescent materials 193, 192 have a shorter afterglow time than the red and green fluorescent materials 189, 191.

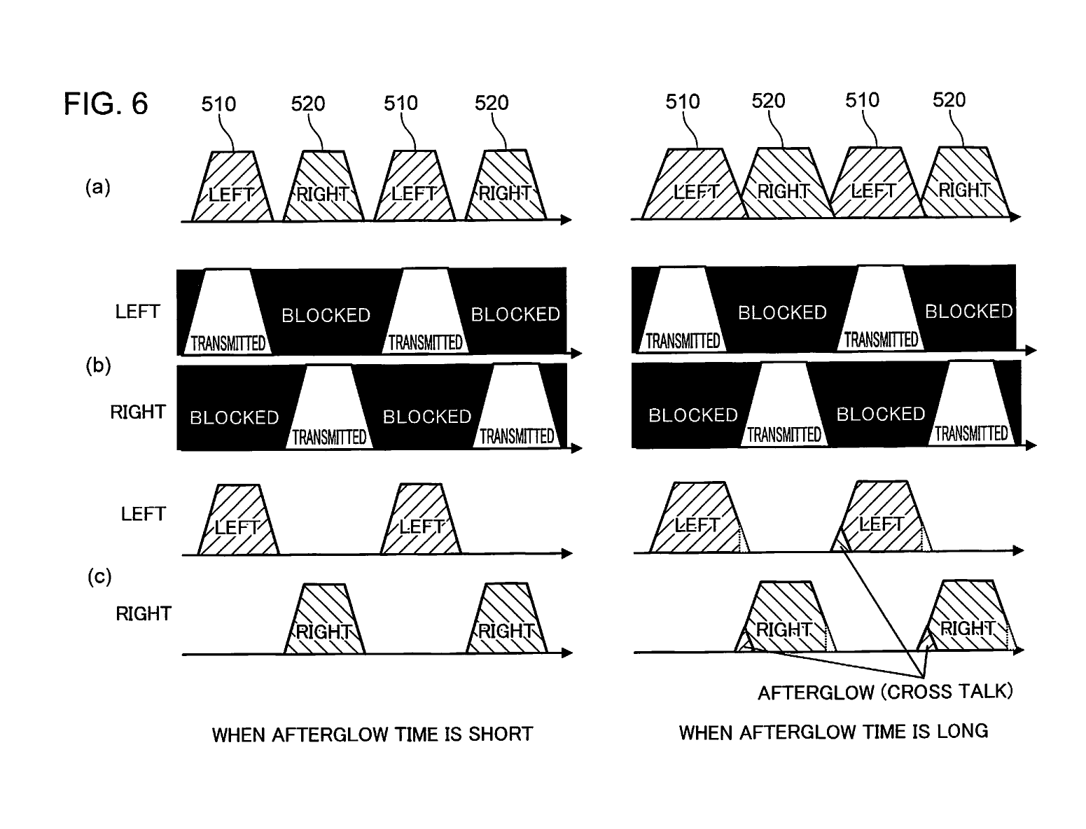

FIG. 6 is a schematic timing chart showing effects of the afterglow time on the video viewed by the viewer. A left diagram in FIG. 6 is a timing chart under a short afterglow time. A right diagram in FIG. 6 is a timing chart under a long afterglow time. Section (a) in FIG. 6 shows the frame image displayed by the display portion 270. Section (b) in FIG. 6 shows operation of the optical filter portion 410 of the eyeglass device 400. Section (c) in FIG. 6 shows the video viewed by the viewer. The effects of the afterglow time on the video perceived by the viewer are described with reference to FIGS. 1A to 2 as well as FIGS. 5 and 6.

As shown in Section (a) of FIG. 6, left and right frame images 510, 520 are alternately displayed by the display portion 270. As shown in Section (b) of FIG. 6, the left filter 411 of the optical filter portion 410 increases the light amount reaching the left eye of the viewer in synchronization with the display of the left frame image 510 whereas the left filter 411 reduces the light amount reaching the left eye of the viewer during the display of the right frame image 520. The right filter 412 of the optical filter portion 410 increases the light amount reaching the right eye of the viewer in synchronization with the display of the right frame image 520 whereas the right filter 412 reduces the light amount reaching the right eye of the viewer during the display of the left frame image 510.

As shown in Section (a) of FIG. 6, if the afterglow time is short, there is no temporal overlap between the displays of the left and right frame images 510, 520. If the afterglow time is long, on the other hand, there is the temporal overlap between the displays of the left and right frame images 510, 520. Accordingly, if the afterglow time is long, the afterglow from the right frame image 520 is perceived by the left eye and the afterglow from the left frame image 510 is perceived by the right eye. As a result, the viewer may not comfortably enjoy viewing the stereoscopic video. If the afterglow time is short, on the other hand, the left frame image 510 may be viewed without perception of the afterglow from the right frame image by the left eye. The right frame image 520 may be viewed without perception of the afterglow from the left frame image 510 by the right eye. Thus, if the afterglow time is short, the viewer may comfortably enjoy viewing the stereoscopic video.

### (Generation of Conversion Signal)

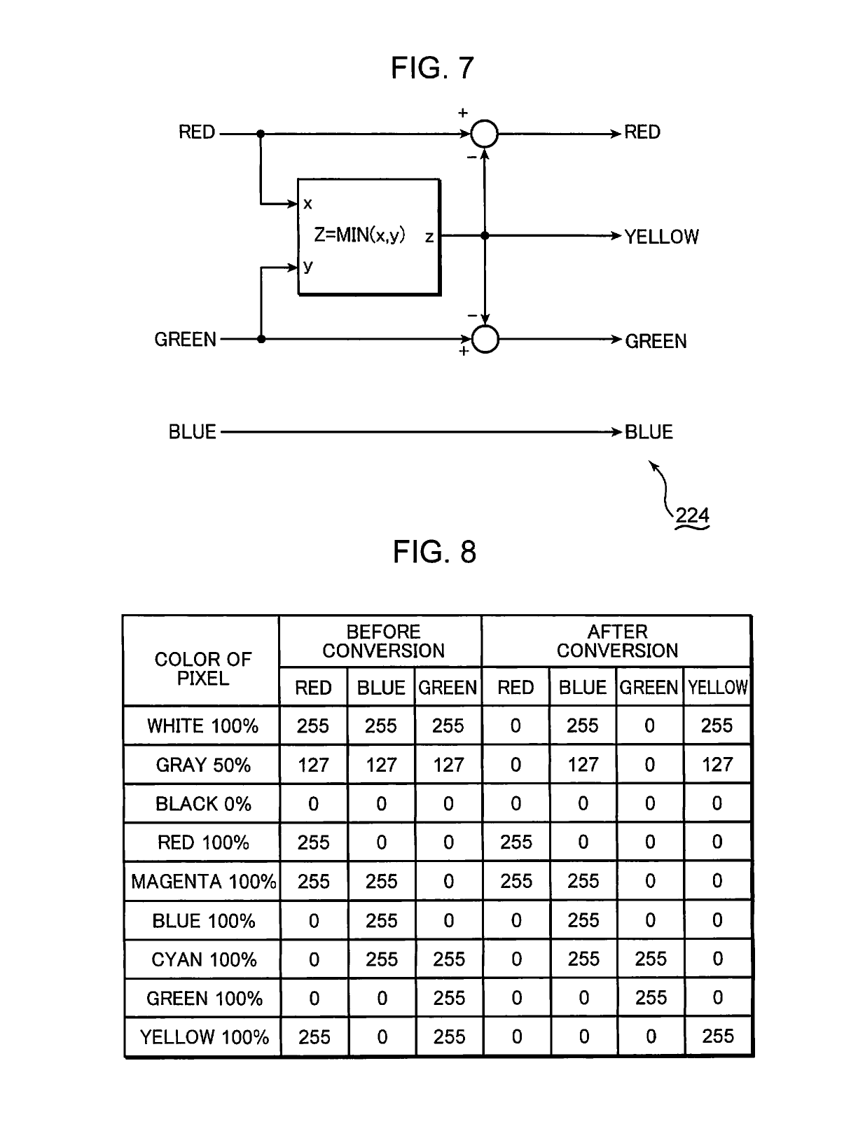

FIG. 7 schematically shows generation of the conversion signal by the converter 224. The generation of the conversion signal by the converter 224 is described with reference to FIGS. 1A, 1B, 3, 4 and 7.

As described with reference to FIGS. 1A and 1B, the video signal is output from the stereoscopic signal processor 222 to the converter 224. The video signal from the stereoscopic signal processor 222 represents the display color of each pixel 171 by the first to third luminosity values corresponding to the red, green and blue hues, respectively.

In FIG. 7, the first luminosity value corresponding to the red hue is represented by the symbol “x”. The second luminosity value corresponding to the green hue is represented by the symbol “y”. As shown in FIG. 7, the converter 224 determines smaller one (represented in FIG. 7 by the symbol “z”) of the first luminosity value “x”, which corresponds to the red hue and the second luminosity value “y”, which corresponds to the green hue, as a third converted luminosity value corresponding to the yellow sub-pixel 174. The converter 224 then outputs a yellow conversion signal to cause plasma emission of the yellow fluorescent material 192 of the yellow sub-pixel 174 at the determined third converted luminosity value.

The converter 224 also determines a difference value between the first luminosity value “x” and the smaller one “z” of the first luminosity value “x”, which corresponds to the red hue, and the second luminosity value “y”, which corresponds to the green hue, as a first converted luminosity value corresponding to the red sub-pixel 172. The converter 224 then outputs a red conversion signal to cause plasma emission of the red fluorescent material 189 of the red sub-pixel 172 at the determined first converted luminosity value.

Likewise, the converter 224 determines a difference value between the second luminosity value “y” and the smaller one “z” of the first luminosity value “x”, which corresponds to the red hue, and the second luminosity value “y”, which corresponds to the green hue, as a second converted luminosity value corresponding to the green sub-pixel 173. The converter 224 then outputs a green conversion signal to cause plasma emission of the green fluorescent material 191 of the green sub-pixel 173 at the determined second converted luminosity value.

In this embodiment, the third luminosity value corresponding to the blue hue in the video signal from the stereoscopic signal processor 222 is used as the fourth converted luminosity value corresponding to the blue sub-pixel 175 without being subjected to the conversion process. Therefore, the converter 224 outputs a blue conversion signal to cause plasma emission of the blue fluorescent material 193 of the blue sub-pixel 175 at the fourth converted luminosity value, which is equal to the third luminosity value.

FIG. 8 shows results of the conversion process shown in FIG. 7. The numerical values shown in FIG. 8 represent the luminosity value of each hue on a 256 gray scale, respectively. It should be noted that FIG. 8 shows conversion results from the specific hues, but the conversion processes shown in FIG. 7 may be suitably applied to other hues. The conversion signal generation by the converter 224 is described with reference to FIGS. 1A, 1B, 3, 5, 7 and 8.

For example, if the video signal from the stereoscopic signal processor 222 represents the display color of the pixel 171 in a gray hue, the video signal allocates a luminosity value “127” to the first luminosity value corresponding to the red hue, the second luminosity value corresponding to the green hue, and the third luminosity value corresponding to the blue hue, respectively. As described with reference to FIG. 7, the converter 224 compares the value allocated to the first luminosity value “x” with the value allocated to the second luminosity value “y”. In the case of the gray hue, the first and second luminosity values are equal, so that the converter 224 allocates a value of “127” to the third converted luminosity value corresponding to the yellow sub-pixel 174. The converter 224 then outputs the yellow conversion signal. As a result, the yellow sub-pixel 174 performs plasma emission at the luminosity value of “127”.

Meanwhile, by means of the difference calculation described with reference to FIG. 7, the converter 224 allocates a value of “0” to both the first and second converted luminosity values, which correspond to the red and green sub-pixel 172, 173, respectively, so that the converter 224 outputs the red and green conversion signals. The converter 224 allocates a value of “127”, which is the value allocated to the blue hue by the video signal from the stereoscopic signal processor 222, to the fourth converted luminosity value corresponding to the blue sub-pixel 175. The converter 224 then outputs the blue conversion signal.

Accordingly, in the conversion process described with reference to FIG. 7, the first converted luminosity value corresponding to the red sub-pixel 172, of which the afterglow time is relatively long, is set to be lower than the first luminosity value corresponding to the red hue in the video signal. The second converted luminosity value of the green sub-pixel 173, of which the afterglow time is relatively long, is also set to be lower than the second luminosity value corresponding to the green hue in the video signal. As a result, the afterglow time of the pixel 171 becomes shorter than an afterglow time under no conversion process.

If the video signal from the stereoscopic signal processor 222 represents black, red, magenta, blue, cyan and green hues out of the “pixel colors” shown in FIG. 8 as the display color, a value of “0” is allocated to at least one of the first and second luminosity values, which correspond to the red and green hues, respectively. In this case, the value of the third converted luminosity value corresponding to the yellow sub-pixel 174 becomes “0”. Therefore, according to the conversion process described with reference to FIG. 7, the yellow conversion signal is output if a value of “0” is allocated neither the first luminosity value corresponding to the red hue nor the second luminosity value corresponding to the green hue.

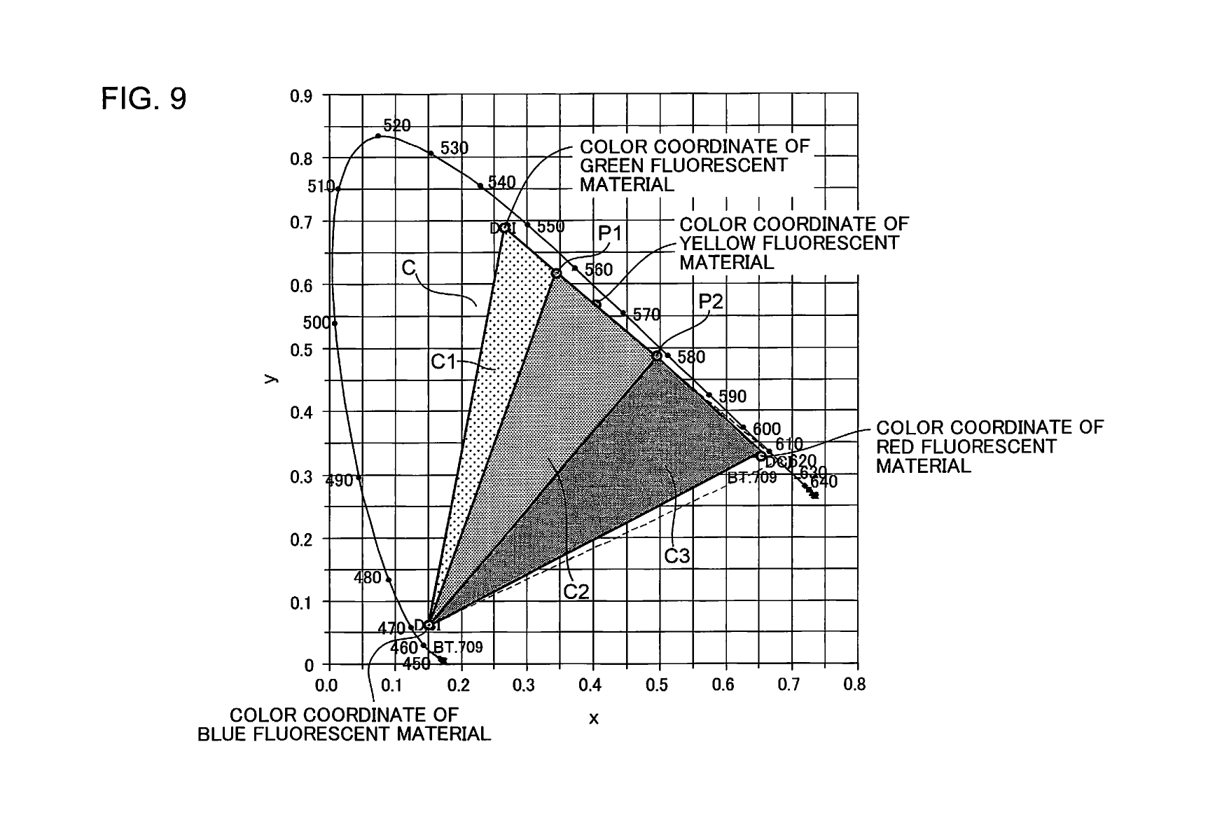

FIG. 9 is a chromaticity diagram showing effects of the conversion process described with reference to FIG. 7. A curve in FIG. 9 is a curve of pure spectral colors. A triangular region in FIG. 9 shows display colors which can be displayed by the display portion 270. Vertices of the triangular region correspond to color coordinates of the red fluorescent material (YVP fluorescent material) 189, the green fluorescent material (ZSM fluorescent material) 191 and the blue fluorescent material (BAM fluorescent material) 193, respectively. The color coordinate point of the yellow fluorescent material (YAG fluorescent material) 192 is set on a straight line, which connects the color coordinate point of the red fluorescent material 189 to the color coordinate point of the green fluorescent material 191.

A triangular region C shown in FIG. 9 is schematically divided into three triangular regions C1, C2, C3. A hue in the triangular region C1, of which vertices are defined by a substantially intermediate coordinate point P1 positioned between the color coordinate points of the yellow and green fluorescent materials 192, 191 and the color coordinate points of the blue and green fluorescent materials 193, 191, is displayed by light emissions from the green, blue and yellow fluorescent materials 191, 193 and 192. A hue in the triangular region C3, of which vertices are defined by a substantially intermediate coordinate point P2 positioned between the coordinate point P1 and the color coordinate point of the red fluorescent material 189, the color coordinate points of the red and blue fluorescent materials 189, 193, is displayed by light emissions from the red, blue and yellow fluorescent materials 189, 193 and 192. A hue in the triangular region C2, of which vertices are defined by the coordinate points P1, P2 and the color coordinate point of the blue fluorescent material 193 is displayed by light emissions from the blue and yellow fluorescent materials 193, 192.

Therefore, according to the conversion process described with reference to FIG. 7, a large number of hues are displayed by the light emissions from the blue and yellow fluorescent materials 193, 192. If the hue of the triangular region C1 is displayed, the first converted luminosity value corresponding to the red sub-pixel 172 is preferably reduced. If the hue of the triangular region C3 is displayed, the second converted luminosity value corresponding to the green sub-pixel 173 is also preferably reduced.

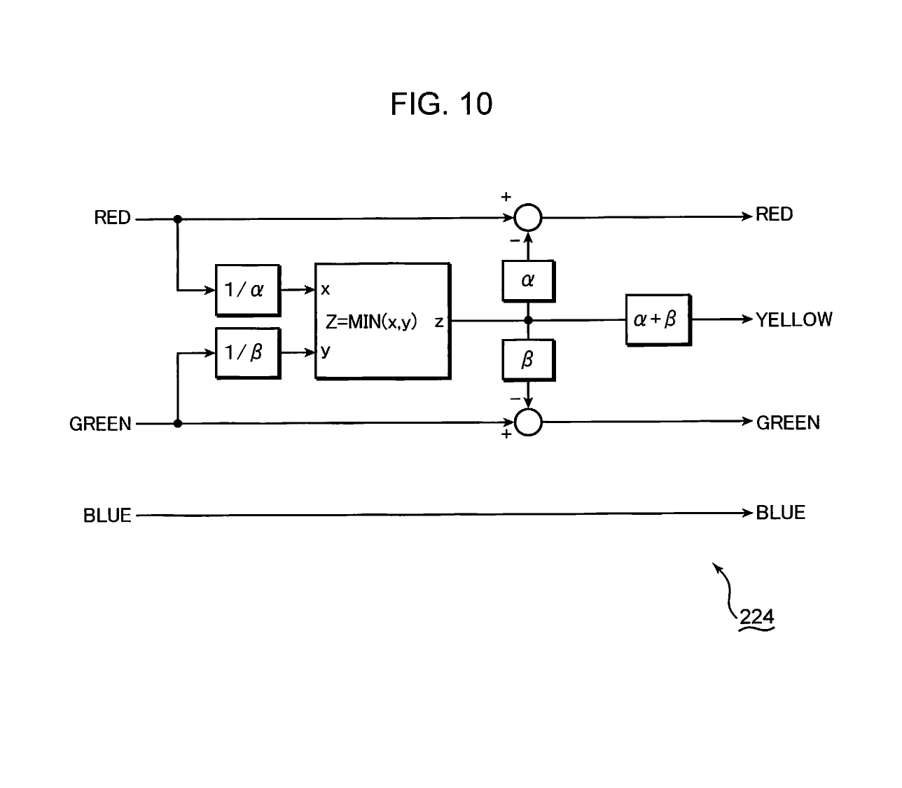

FIG. 10 schematically shows another method for generating the conversion signal by the converter 224. The conversion signal generation by the converter 224 is described with reference to FIGS. 1A, 1B, 3, 4, 8 and 10.

As described above with reference to FIGS. 1A and 1B, the video signal is output from the stereoscopic signal processor 222 to the converter 224. The video signal from the stereoscopic signal processor 222 represents the display color of each pixel 171 by the first to third luminosity values, which correspond to the red, green and blue hues, respectively.

In this embodiment, light emission of the red sub-pixel 172 at a predetermined first emission luminosity value (represented by the symbol “α” in FIG. 10) and light emission of the green sub-pixel 173 at a predetermined second emission luminosity value (represented by the symbol “β” in FIG. 10) results in a substantially equivalent hue and luminosity value to light emission at a third emission luminosity value “α+β”, which is obtained as a sum of the first and second emission luminosity values “α” and “β”.

The converter 224 divides the first luminosity value corresponding to the red hue, which is defined by the video signal from the stereoscopic signal processor 222, by the first emission luminosity value “α” to calculate a value “x” shown in FIG. 10. The converter 224 also divides the second luminosity value corresponding to the green hue, which is defined by the video signal from the stereoscopic signal processor 222, by the second emission luminosity value “β” to calculate a value “y” shown in FIG. 10. The converter 224 then determines smaller one of the values “x” and “y” as a value “z”. The converter 224 multiplies the third emission luminosity value “α+β” by the determined value “z”, so that the converter 224 then sets the resultant value from the multiplication as the third converted luminosity value corresponding to the yellow sub-pixel 174. The converter 224 then outputs the yellow conversion signal to cause plasma emission of the yellow fluorescent material 192 of the yellow sub-pixel 174 at the determined third converted luminosity value.

The converter 224 multiplies the first emission luminosity value “α” by the value “z”, and then determines a difference value between the first luminosity value corresponding to the red hue, which is defined by the video signal from the stereoscopic signal processor 222, and the resultant luminosity value from the multiplication of the values “α” by “z” as the first converted luminosity value, which corresponds to the red sub-pixel 172. The converter 224 then outputs the red conversion signal to cause plasma emission of the red fluorescent material 189 of the red sub-pixel 172 at the determined first converted luminosity value.

Likewise, the converter 224 multiplies the second emission luminosity value “β” by the value “z” and then determines a difference value between the second luminosity value corresponding to the green hue, which is defined by the video signal from the stereoscopic signal processor 222, and the resultant luminosity value from the multiplication of the values of “β” by “z” as the second converted luminosity value, which corresponds to the green sub-pixel 173. The converter 224 then outputs the green conversion signal to cause plasma emission of the green fluorescent material 191 of the green sub-pixel 173 at the determined second converted luminosity value.

In this embodiment, the third luminosity value corresponding to the blue hue in the video signal, which is output by the stereoscopic signal processor 222, is used as the fourth converted luminosity value corresponding to the blue sub-pixel 175 without being subjected to conversion process. Accordingly, the converter 224 outputs the blue conversion signal to cause plasma emission of the blue fluorescent material 193 of the blue sub-pixel 175 at the fourth converted luminosity value, which is equivalent to the third luminosity value.

Like the described methodologies with reference to FIGS. 8 and 9, in the conversion process described with reference to FIG. 10, the luminosity values of the red and green sub-pixels 172, 173, which have relatively long afterglow times, respectively, are reduced as well to preferably shorten the afterglow time of the pixel 171.

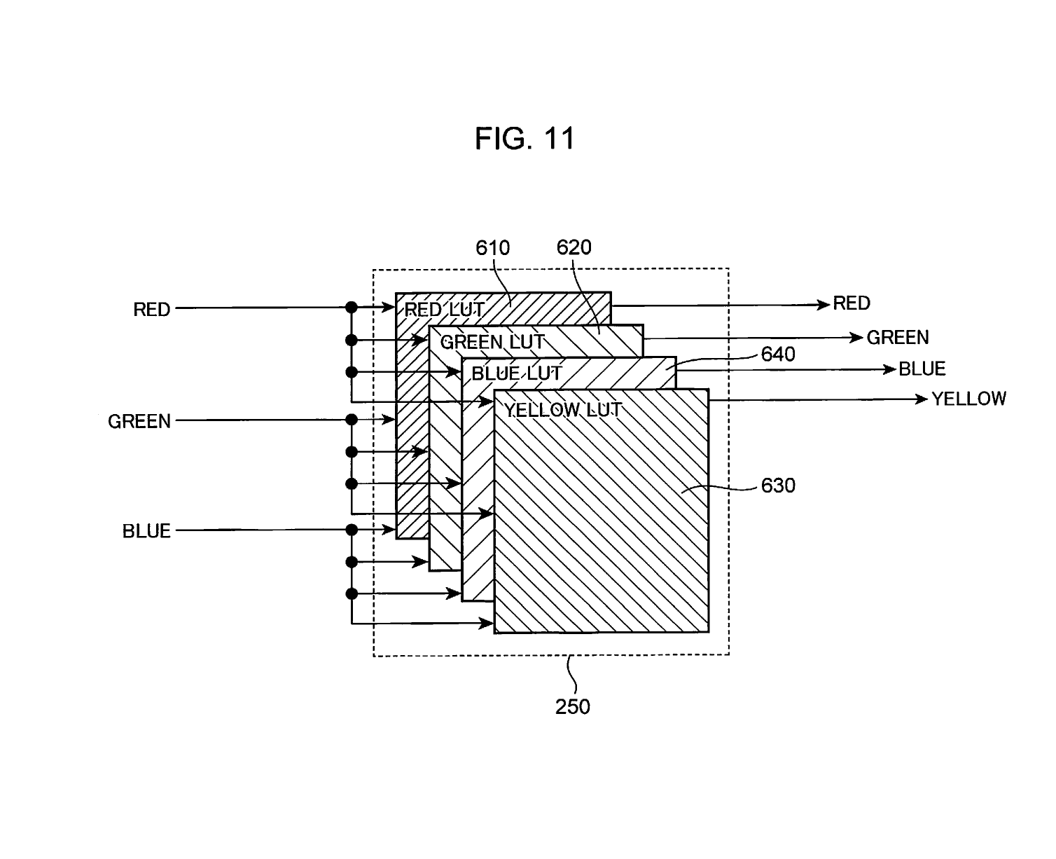

FIG. 11 schematically shows yet another method for generating the conversion signal by the converter 224. The conversion signal generation by the converter 224 is described with reference to FIGS. 1A, 1B, 3, 4, 8, 9 and 11.

As described above with reference to FIGS. 1A and 1B, the video signal is output from the stereoscopic signal processor 222 to the converter 224. The video signal from the stereoscopic signal processor 222 represents the display color of each pixel 171 by means of the first to third luminosity values, which correspond to the red, green and blue hues, respectively.

In this embodiment, the storage portion 250 stores in advance a red lookup table 610 for outputting the red conversion signal, a green lookup table 620 for outputting the green conversion signal, a yellow lookup table 630 for outputting the yellow conversion signal and a blue lookup table 640 for outputting the blue conversion signal.

The converter 224 refers to the red lookup table (red LUT) 610, the green lookup table (green LUT) 620, the yellow lookup table (yellow LUT) 630 and the blue lookup table (blue LUT) 640 to determine the first to fourth converted luminosity values, which correspond to the red, green, yellow and blue sub-pixels 172, 173, 174 and 175, on the basis of the first to third luminosity values which the video signal from the stereoscopic signal processor 222 defines for the red, green and blue hues, respectively.

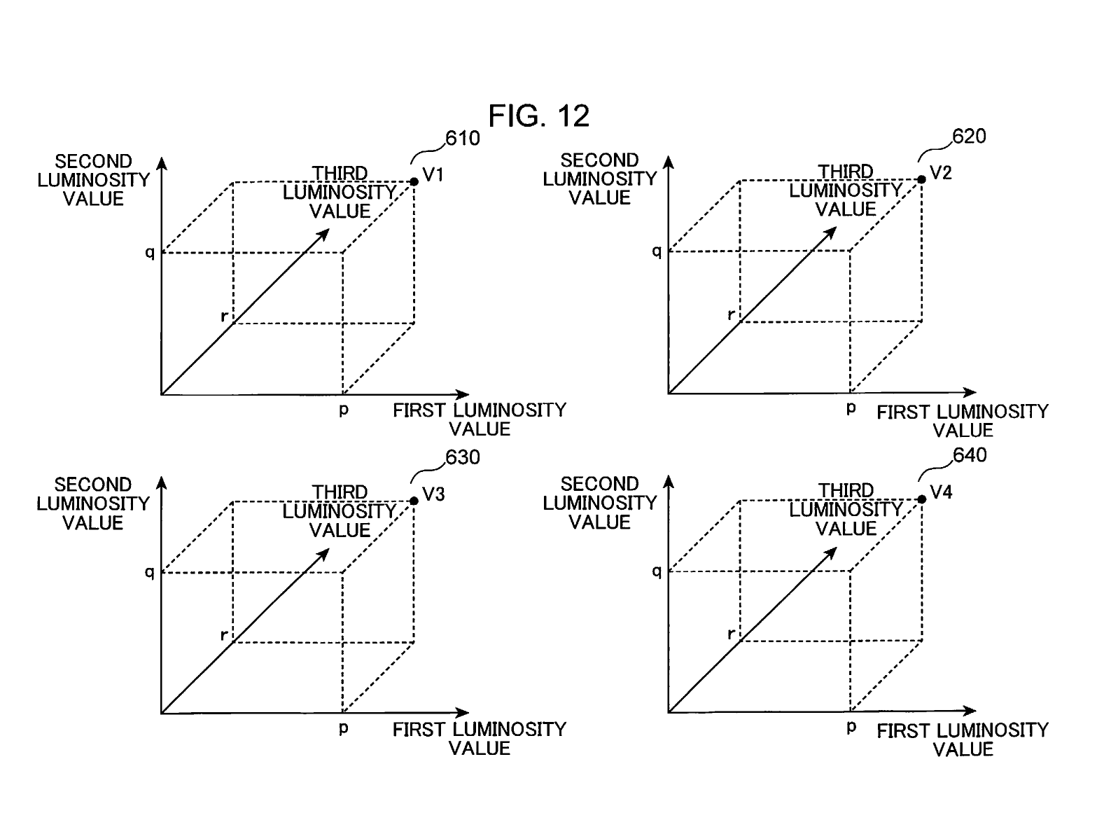

FIG. 12 schematically shows a method for determining the first to fourth converted luminosity values by means of the red, green, yellow and blue lookup tables 610, 620, 630 and 640. The method for determining the first to fourth converted luminosity values is described with reference to FIGS. 11 and 12.

Axes on the graphs shown in FIG. 12 show the first to third luminosity values which the video signal from the stereoscopic signal processor 222 defines for the red, green and blue hues, respectively. In this embodiment, values at each point in the coordinate systems of the red, green, yellow and blue lookup table 610, 620, 630 and 640 are determined in advance.

Values of the first to third luminosity values, which the video signal from the stereoscopic signal processor 222 defines for the red, green and blue hues, respectively, are represented by symbols “p”, “q” and “r”, respectively. The converter 224 looks up coordinate point values determined on each of the coordinate systems of the red, green, yellow and blue lookup tables 610, 620, 630 and 640. In FIG. 12, a value of the coordinate point (p, q, r) on the coordinate system of the red lookup table 610 is indicated by the symbol “V1”. A value of the coordinate point (p, q, r) on the coordinate system of the green lookup table 620 is indicated by the symbol “V2”. A value of the coordinate point (p, q, r) on the coordinate system of the yellow lookup table 630 is indicated by the symbol “V3”. A value of the coordinate point (p, q, r) on the coordinate system of the blue lookup table 640 is indicated by the symbol “V4”.

The converter 224 determines the value “V1” as the first converted luminosity value corresponding to the red sub-pixel 172 and outputs the red conversion signal to emit light from the red sub-pixel 172. Likewise, the converter 224 determines the value “V2” as the second converted luminosity value corresponding to the green sub-pixel 173 and outputs the green conversion signal to emit light from the green sub-pixel 173. The converter 224 also determines the value “V3” as the third converted luminosity value corresponding to the yellow sub-pixel 174 and outputs the yellow conversion signal to emit light from the yellow sub-pixel 174. Likewise, the converter 224 determines the value “V4” as the fourth converted luminosity value corresponding to the blue sub-pixel 175 and outputs the blue conversion signal to emit light from the blue sub-pixel 175. If the red, green, yellow and blue sub-pixels 172, 173, 174 and 175 emit the light at the first to fourth converted luminosity value “V1”, “V2”, “V3” and “V4”, respectively, an emitted display color corresponds to the display color of the pixel 171 which the video signal from the stereoscopic signal processor defines by means of the first to third luminosity values that correspond to the red, green and blue hues, respectively.

The point values on the coordinate system of the red lookup table 610 may be determined so that if neither the value “p” of the first luminosity value nor the value “q” of the second luminosity value is zero, the value “V1” becomes smaller than the value “p”. Likewise, the point values on the coordinate system of the green lookup table 620 may be determined so that if neither the value “p” of the first luminosity value nor the value “q” of the second luminosity value is zero, the value “V2” is smaller than the value “q”. The point values on the coordinate system of the yellow lookup table 630 may be determined so that if neither the value “p” of the first luminosity value nor the value “q” of the second luminosity value is zero, the value “V3” is larger than zero.

As described in the aforementioned embodiment, the afterglow time of the pixel 171 is preferably shortened if there are a decrease in luminosity values of the red and green sub-pixels 172, 173, which have a relatively long afterglow time, and an increase in luminosity value of the yellow sub-pixel 174, which has a relatively short afterglow time.

With the configuration described in the aforementioned embodiment, the yellow sub-pixel emits light so that a display color corresponding to the display color represented by the video signal is displayed under the decreased luminosity values of the red and green sub-pixels. For example, if white is displayed on a conventional plasma display, three sub-pixels such as the red, green and blue sub-pixels have to emit light. In the plasma display according to this embodiment, on the other hand, white may be displayed by emitting light from two sub-pixels such as the yellow and blue sub-pixels. A total plasma discharge amount required for a self-emitting display apparatus such as a plasma display to emit light is typically related to power consumption. According to the principles of this embodiment, less sub-pixels are required to simultaneously emit light to display a specific color, which results in less power consumption.

It should be noted that the video system 300, which includes the display apparatus 100 for displaying stereoscopic video and the eyeglass device 400 for performing the stereoscopic vision assistance, is exemplified in the aforementioned embodiment. Alternatively, the display apparatus may be a video display apparatus without displaying a stereoscopic video like conventional display devices. According to the principles of this embodiment, afterglow may be reduced between frames displayed by the video display apparatus without displaying a stereoscopic video. Alternatively, the principles of this embodiment may be advantageously applied to reduce power consumption of the video display apparatus without displaying stereoscopic video.

The aforementioned embodiment mainly includes the following configurations. A display apparatus with the following configurations may provide a video with little afterglow.

A display apparatus according to one aspect of the aforementioned embodiment includes: an input port to which a video signal is input, the video signal representing a display color with a first luminosity value corresponding to a red hue, a second luminosity value corresponding to a green hue, and a third luminosity value corresponding to a blue hue; a display portion including a pixel having a red sub-pixel which causes plasma emission in the red hue, a green sub-pixel which causes plasma emission in the green hue, a blue sub-pixel which causes plasma emission in the blue hue, and a yellow sub-pixel which causes plasma emission in a yellow hue; and a converter configured to convert the video signal into a conversion signal so that the red, green, blue and yellow sub-pixels emit light on the display portion to display a display color which corresponds to the represented display color by the video signal, wherein the conversion signal output by the converter includes at least one of a red conversion signal to cause the plasma emission of the red sub-pixel at a first converted luminosity value that is lower than the first luminosity value and a green conversion signal to cause the plasma emission of the green sub-pixel at a second converted luminosity value that is lower than the second luminosity value, and a yellow conversion signal to cause the plasma emission of the yellow sub-pixel, the plasma emission by the yellow sub-pixel results in a shorter afterglow time than resultant afterglow times from the plasma emissions by the red and green sub-pixels, the red sub-pixel causes the plasma emission at the first converted luminosity value, and the green sub-pixel causes the plasma emission at the second converted luminosity value.

According to the aforementioned configuration, the video signal represents the display color by the first to third luminosity values corresponding to the red, green and blue hues, respectively. The pixel of the display portion includes the red, green, blue and yellow sub-pixels which cause plasma emissions in the red, green, blue and yellow hues, respectively. The converter of the display apparatus converts the video signal into the conversion signal so that the red, green, blue and yellow sub-pixels emit light on the display portion to display a display color which corresponds to the represented display color by the video signal. The conversion signal output by the converter includes at least one of the red conversion signal to cause the plasma emission of the red sub-pixel at the first converted luminosity value that is lower than the first luminosity value and the green conversion signal to cause the plasma emission of the green sub-pixel at the second converted luminosity value that is lower than the second luminosity value, and the yellow conversion signal to cause the plasma emission of the yellow sub-pixel. Thus, the luminosity values of the red and green sub-pixels are decreased while the yellow sub-pixel causes the plasma emission with a shorter afterglow time than the red and green sub-pixels so as to display a display color which corresponds to the represented display color by the video signal. Therefore, the display portion may display the display color with the short afterglow time. Consequently, the display apparatus may display a video with little afterglow.

In the aforementioned configuration, the converter preferably includes a storage portion configured to store a lookup table to determine the first converted luminosity value, the second converted luminosity value, a third converted luminosity value at which the yellow sub-pixel causes the plasma emission, and a fourth converted luminosity value at which the blue sub-pixel causes the plasma emission, based on the first, second and third luminosity values.

According to the aforementioned configuration, the converter includes the storage portion which stores the lookup table to determine the first to fourth converted luminosity value of the red, green, yellow and blue sub-pixels, respectively, on the basis of the first to third luminosity values. Accordingly, the first to fourth converted luminosity values of the red, green, yellow and blue sub-pixels are appropriately determined by means of the lookup table, respectively.

In the aforementioned configuration, the converter preferably determines smaller one of the first and second luminosity values as a third converted luminosity value at which the yellow sub-pixel causes the plasma emission, and outputs the yellow conversion signal to emit light from the yellow sub-pixel at the third converted luminosity value.

According to the aforementioned configuration, the converter determines the smaller one of the first and second luminosity values as the third converted luminosity value of the yellow sub-pixel. The converter then outputs the yellow conversion signal. The converter reduces the luminosity values of the red and green sub-pixels, respectively. Accordingly, the yellow sub-pixel emits light with a short afterglow time at the third converted luminosity value while the red and/or green sub-pixels, of which afterglow is longer than the yellow sub-pixel, emit light at decreased luminosity values. Therefore, the display portion may display the display color with a short afterglow time. As a result, the display apparatus may display a video with little afterglow.

In the aforementioned configuration, the converter preferably determines a difference value between the first luminosity value and the smaller one of the first and second luminosity values as the first converted luminosity value.

According to the aforementioned configuration, the converter determines the one of the first and second luminosity values as the third converted luminosity value of the yellow sub-pixel. The converter then outputs the yellow conversion signal. The converter determines the difference value between the first luminosity value and the one of the first and second luminosity values as the first converted luminosity value. The converter then outputs the red conversion signal for causing the red sub-pixel to emit light. Thus, the display portion may display the display color with a short afterglow time. As a result, the display apparatus may display a video with little afterglow.

In the aforementioned configuration, the converter preferably determines a difference value between the second luminosity value and the smaller one of the first and second luminosity values as the second converted luminosity value.

According to the aforementioned configuration, the converter determines the smaller one of the first and second luminosity values as the third converted luminosity value of the yellow sub-pixel. The converter then outputs the yellow conversion signal. The converter determines the difference value between the second luminosity value and the smaller one of the first and second luminosity values as the second converted luminosity value. The converter then outputs the green conversion signal for causing the green sub-pixel to emit light. Therefore, the display portion may display the display color with a short afterglow time. As a result, the display apparatus may display a video with little afterglow.

In the aforementioned configuration, the converter preferably multiplies a third emission luminosity value by smaller one of a resultant value from division of the first luminosity value by a predetermined first emission luminosity value and a resultant value from division of the second luminosity value by a predetermined second emission luminosity value to determine a third converted luminosity value, at which the yellow sub-pixel causes the plasma emission, the third emission luminosity value obtained as a sum of the first and second emission luminosity values, the converter outputs the yellow conversion signal to emit light from the yellow sub-pixel at the third converted luminosity value.

According to the aforementioned configuration, the converter multiplies the third emission luminosity value by the smaller one of the resultant value from division of the first luminosity value by the predetermined first emission luminosity value and the resultant value from division of the second luminosity value by the predetermined second emission luminosity value, so that the converter determine the third converted luminosity value of the plasma emission of the yellow sub-pixel. It should be noted that the third emission luminosity value is obtained as a sum of the first and second emission luminosity values. The converter then outputs the yellow conversion signal. The converter reduces the luminosity values of the red and green sub-pixels, respectively. Therefore, the yellow sub-pixel emits light with a short afterglow time at the third converted luminosity value while the red and/or green sub-pixels, of which afterglow time is longer than the yellow sub-pixel, emit light at decreased luminosity values. Accordingly the display portion may display the display color with a short afterglow time. As a result, the display apparatus may display a video with little afterglow.

In the aforementioned configuration, the converter preferably determines a difference value between the first luminosity value and a luminosity value, which is a resultant value from multiplication of the first emission luminosity value by smaller one of a resultant value from division of the first luminosity value by the first emission luminosity value and a resultant value from division of the second luminosity value by the second emission luminosity value, as the first converted luminosity value.

According to the aforementioned configuration, the converter outputting the yellow conversion signal determines the difference value between the first luminosity value and the luminosity value, which is the resultant value from multiplication of the first emission luminosity value by the smaller one of a resultant value from division of the first luminosity value by the first emission luminosity value and the resultant value from division of the second luminosity value by the second emission luminosity value, as the first converted luminosity value. The converter then outputs the red conversion signal for causing the red sub-pixel to emit light. Accordingly, the display portion may display the display color with a short afterglow time. As a result, the display apparatus may display a video with little afterglow.

In the aforementioned configuration, the converter preferably determines a difference value between the second luminosity value and a luminosity value, which is a resultant value from multiplication of the second emission luminosity value by the smaller one of the resultant value from division of the first luminosity value by the first emission luminosity value and the resultant value from division of the second luminosity value by the second emission luminosity value, as the second converted luminosity value.

According to the aforementioned configuration, the converter outputting the yellow conversion signal determines the difference value between the second luminosity value and the luminosity value, which is a resultant value from multiplication of the second emission luminosity value by the smaller one of the resultant value from division of the first luminosity value by the first emission luminosity value and the resultant value from division of the second luminosity value by the second emission luminosity value, as the second converted luminosity value. The converter then outputs the green conversion signal for causing the green sub-pixel to emit light. Therefore, the display portion may display the display color with a short afterglow time. As a result, the display apparatus may display a video with little afterglow.

In the aforementioned configuration, the blue or red sub-pixel is preferably situated between the yellow and green sub-pixels.

According to the aforementioned configuration, the blue or red sub-pixel with a low spectral luminous efficiency is situated between the yellow and green sub-pixels with a high spectral luminous efficiency. Therefore the display color defined by the video signal may be appropriately displayed.

The principles according to the present embodiment may be preferably applied to self-emitting display apparatuses such as plasma displays.

1. A display apparatus comprising:
an input port to which a video signal is input, the video signal representing a display color with a first luminosity value corresponding to a red hue, a second luminosity value corresponding to a green hue, and a third luminosity value corresponding to a blue hue;
a display portion including a pixel having a red sub-pixel which causes plasma emission in the red hue, a green sub-pixel which causes plasma emission in the green hue, a blue sub-pixel which causes plasma emission in the blue hue, and a yellow sub-pixel which causes plasma emission in a yellow hue; and
a converter configured to convert the video signal into a conversion signal so that the red, green, blue and yellow sub-pixels emit light on the display portion to display a display color which corresponds to the represented display color by the video signal, wherein
the conversion signal output by the converter includes at least one of a red conversion signal to cause the plasma emission of the red sub-pixel at a first converted luminosity value that is lower than the first luminosity value and a green conversion signal to cause the plasma emission of the green sub-pixel at a second converted luminosity value that is lower than the second luminosity value, and a yellow conversion signal to cause the plasma emission of the yellow sub-pixel,
the plasma emission by the yellow sub-pixel results in a shorter afterglow time than resultant afterglow times from the plasma emissions by the red and green sub-pixels,
the red sub-pixel causes the plasma emission at the first converted luminosity value, and
the green sub-pixel causes the plasma emission at the second converted luminosity value.

2. The display apparatus according to claim 1, wherein the converter comprises a storage portion configured to store a lookup table to determine the first converted luminosity value, the second converted luminosity value, a third converted luminosity value at which the yellow sub-pixel causes the plasma emission, and a fourth converted luminosity value at which the blue sub-pixel causes the plasma emission, based on the first, second and third luminosity values.

3. The display apparatus according to claim 1, wherein the converter determines smaller one of the first and second luminosity values as a third converted luminosity value at which the yellow sub-pixel causes the plasma emission, and outputs the yellow conversion signal to emit light from the yellow sub-pixel at the third converted luminosity value.

4. The display apparatus according to claim 3, wherein the converter determines a difference value between the first luminosity value and the smaller one of the first and second luminosity values as the first converted luminosity value.

5. The display apparatus according to claim 3, wherein the converter determines a difference value between the second luminosity value and the smaller one of the first and second luminosity values as the second converted luminosity value.

6. The display apparatus according to claim 1, wherein the converter multiplies a third emission luminosity value by smaller one of a resultant value from division of the first luminosity value by a predetermined first emission luminosity value and a resultant value from division of the second luminosity value by a predetermined second emission luminosity value to determine a third converted luminosity value, at which the yellow sub-pixel causes the plasma emission, the third emission luminosity value obtained as a sum of the first and second emission luminosity values,
the converter outputs the yellow conversion signal to emit light from the yellow sub-pixel at the third converted luminosity value.

7. The display apparatus according to claim 6, wherein the converter determines a difference value between the first luminosity value and a luminosity value, which is a resultant value from multiplication of the first emission luminosity value by smaller one of a resultant value from division of the first luminosity value by the first emission luminosity value and a resultant value from division of the second luminosity value by the second emission luminosity value, as the first converted luminosity value.

8. The display apparatus according to claim 7, wherein the converter determines a difference value between the second luminosity value and a luminosity value, which is a resultant value from multiplication of the second emission luminosity value by the smaller one of the resultant value from division of the first luminosity value by the first emission luminosity value and the resultant value from division of the second luminosity value by the second emission luminosity value, as the second converted luminosity value.

9. The display apparatus according to claim 1, wherein the blue or red sub-pixel is situated between the yellow and green sub-pixels.
